(19) United States
(12) Patent Application Publication
(10) Pub. No.: US 2021/0340679 A1
(43) Pub. Date: Nov. 4, 2021

(54) SYSTEMS AND METHODS FOR MONITORING INTEGRATED PASSIVE ANODES

(71) Applicant: Rheem Manufacturing Company, Atlanta, GA (US)

(72) Inventors: Robert Stuart Glass, Tuscaloosa, AL (US); Sergio Montalgo Salazar, Oxnard, CA (US)

(21) Appl. No.: 16/864,316

(22) Filed: May 1, 2020

(51) Int. Cl. C23F 13/22; C23F 13/14; C23F 13/20; G01N 17/02; G08B 21/18

(52) U.S. Cl. CPC C23F 13/22; C23F 13/14; G08B 21/18; G01N 17/02; C23F 13/20

(57) ABSTRACT

Systems and methods for providing and monitoring corrosion protection are disclosed. The system can include a sacrificial passive anode and a reference electrode. The sacrificial anode and the reference electrode can both be in communication with a component that is subject to corrosion and the liquid contained therein. The sacrificial anode can be electrically connected to the component with a bonding wire. The reference electrode can be electrically connected to an electronic measurement device and the component. As the sacrificial anode is depleted the voltage of the system drops. The difference in the voltage can be monitored over time and can be used in various algorithms to calculate a protection level based on the amount of sacrificial anode remaining. When the protection level drops below a predetermined level, an alert can be provided to inform a user that the sacrificial anode needs to be replaced.

### TECHNICAL FIELD

Examples of the present disclosure relate generally to passive anode protection systems for devices subject to galvanic corrosion, and more specifically to systems and methods for monitoring and maintaining passive anode protection in water heating devices.

### BACKGROUND

Water heating devices such as pool and hot tub heaters, boilers, residential water heaters, and commercial water heaters generally contain a heat exchanger that transfers heat from a heat source (e.g., a gas burner or electric heating element) to the water, glycol, or other medium. The heat can be generated by any of a variety of sources including, for example, combustion, mains electricity, solar heat, or solar electricity. The heat exchanger and associated components that are in contact with the water are often made from metal that corrodes in response to exposure to the water and/or galvanic corrosion due to dissimilar metals in contact with one another in the heat exchangers or system.

One solution for protecting metals from this corrosion is to apply a protective coating. This may be a spray on polymer, paint, or powder coating, galvanizing, sealant, or other coatings. In most cases, however, even the most robust coating will degrade over time. These coatings may also be inappropriate for use on, or inside, heat exchangers—i.e., they can negatively affect heat exchange between the liquid and the heat exchanger.

Another solution for protecting heat exchanger surfaces from corrosion is the use of a sacrificial anode. The anode is typically made from a material, such as zinc, magnesium, or aluminum, that corrodes more readily than the components of the water heating device. The anode is generally more “active” (i.e., has a more negative reduction potential or more positive electrochemical potential) than the heat exchanger, for example, which causes the anode to corrode at a higher rate than the heat exchanger, thereby protecting the heat exchanger from corrosion. Thus, the anode may be made from zinc, for example, while the heat exchanger is made from stainless steel.

FIG. 1 depicts an example of a prior art water heating system 100 for a pool. The system 100 comprises a pump 105 that draws water from a pool, hot tub, or other source and directs the water through a filter 120 and along an inlet pipe 110 to a heater 125. The arrows in FIG. 1 show the general direction of the flow of the water. After the water is heated, it is returned to the pool via a return pipe 130. Generally, the inlet pipe 110 (but could also be the return pipe 130 in some situations) can also include an anode assembly 115, which includes a sacrificial anode 135 that interacts with the water as it flows through the system 100. The anode assembly 115 may also include a housing 140 in which the sacrificial anode 135 is enclosed.

FIG. 2 depicts an example in which the anode assembly 115 is installed on the inlet pipe 110. As shown, the anode assembly 115 can be installed “upside down” on the inlet pipe 110 (e.g., from below the inlet pipe 110). This ensures the anode assembly 115 is almost always submersed, even when the pump 105 is turned off, and also eliminates the need for a bleed valve. In other words, if the anode assembly 115 were installed “right side up” (e.g., from above the inlet pipe 110), air could be trapped in the top of the housing 140, which could uncover the sacrificial anode 135 and would require a bleed valve to remove air from the system.

As the name implies, the inlet pipe 110 can be at the inlet of a heat exchanger 205, which heats the water. The anode assembly 115 can be attached to the inlet pipe 110 such that the sacrificial anode 135 is in communication with the water. The sacrificial anode 135 is also in electrical communication with the inlet pipe 110 and/or the heat exchanger 205. This can be done with a suitably sized bonding wire 210, for example, or in any other suitable manner. The bonding wire 210 can be attached to the heat exchanger 205 with, for example, an eyelet 225 (or any other suitable attachment). The other end of the bonding wire 210, in turn, can be in electrical communication with the sacrificial anode 135 via, for example, a nut 220 and/or bolt 215. Of course, the bonding wire 210 could also be clamped, soldered, welded, or otherwise electrically connected to the inlet pipe 110 and/or the heat exchanger 205.

As water passes through the pipes 110, 130 and the heat exchanger 205, any electrical potential created by the interaction of the components 110, 130, 205 and the water causes the sacrificial anode 135 to corrode at a higher rate than the components 110, 130, 205. Unfortunately, other than visually or manually checking the sacrificial anode 135, there is currently no ready way to determine when the sacrificial anode 135 should be replaced. Indeed, if the housing 140 of the anode assembly 115 is opaque (e.g., metal or opaque plastic), then the anode assembly 115 may even need to be disassembled to inspect the sacrificial anode 135. Even if the housing of the anode assembly 115 is clear, for example, the user still must visually check the sacrificial anode 135 and replace, as necessary. In addition, visual inspection is subjective. In other words, anode protection potential may be already low, but visual inspection does not provide an accurate indication.

In many cases, the anode assembly 115 may be located behind a fenced enclosure, for example, or in a mechanical room making inspection tedious. In a busy world, it is easy to imagine that this particular maintenance item could be overlooked for extended periods of time. In the meantime, multiple internal components of the system 100 (e.g., the pipes 110, 130, heat exchanger 205, pump 105 components are corroding due to the lack of protection. Indeed, because these components are generally internal to the system 100, the next reminder may be a puddle on the floor or a lack of water flow due to a heat exchanger or pump failure caused by corrosion. Corrosion can also reduce the conductivity of the heat exchanger, reducing efficiency and increasing energy consumption.

In view of these shortcomings, there is a need for systems and methods for improved passive anode monitoring for use with water heating devices.

### SUMMARY

Example of the present disclosure include systems and methods for monitoring cathodic protection. The system can include a sacrificial passive anode and a reference electrode, with both elements in communication with a metallic component or structure that is subject to corrosion. The sacrificial anode is electrically connected to the component or structure. In this manner, any voltage potential between the component or structure and ground will cause the sacrificial anode to corrode at a higher rate than the component or structure.

To monitor the condition of the sacrificial anode, the reference electrode can be electrically connected to one or more electronic measurement devices (e.g., a multimeter). The degradation of the sacrificial anode can be measured indirectly by measuring the change in voltage potential of the system over time. In other words, as the sacrificial anode is consumed, the voltage potential of the system, as measured between the reference electrode and the structure, goes down (e.g., from ˜0.5 volts to −0.1 volts or less). In some examples, a controller can be used to automatically monitor these changes.

When the voltage reaches a predetermined level—i.e., the protection level drops below a predetermined level—an alert can be provided to inform a user that the sacrificial anode needs to be replaced. The alert can be provided by activating a light, siren, or other device on, or near, the controller. The alert can also be sent to a mobile device of the user. The alert can also be sent to a website or web portal that can be accessed by the user or their selected service company. When the sacrificial anode is replaced, the alert can be reset, and the system can continue monitoring the electrical properties between the reference electrode and the structure with the sacrificial anode in the circuit, as discussed below.

The reference electrode can comprise a suitably conductive material that is resistant to corrosion and acts as a reference point. Other than some minimal degradation over time, the reference electrode can remain substantially unchanged. Thus, any change in electrical properties is due almost entirely to consumption of the sacrificial anode. The system can prevent the loss of cathodic protection due to lack of maintenance and can prevent damage, such as corrosion, rust, and scale buildup. This can significantly reduce parts and labor costs from the water heating device; and indeed, for any device in the system which is in the electrical circuit between the sacrificial anode and the component or structure. The system can also reduce the energy consumption of the system due to corrosion (e.g., the more corroded the heat exchanger the less efficient it is). In this manner fuel or electricity costs can also be reduced.

These and other aspects, objects, features, and embodiments will be apparent from the following description and the appended claims.

### BRIEF DESCRIPTION OF THE DRAWINGS

Reference will now be made to the accompanying drawings, which are not necessarily drawn to scale, and which are incorporated into, and constitute a portion of, this disclosure. The drawings illustrate various implementations and aspects of the disclosed technology and, together with the description, serve to explain the principles of the disclosed technology. In the drawings:

FIG. 1 is an example a prior art water heating system for a pool or hot tub with a sacrificial anode.

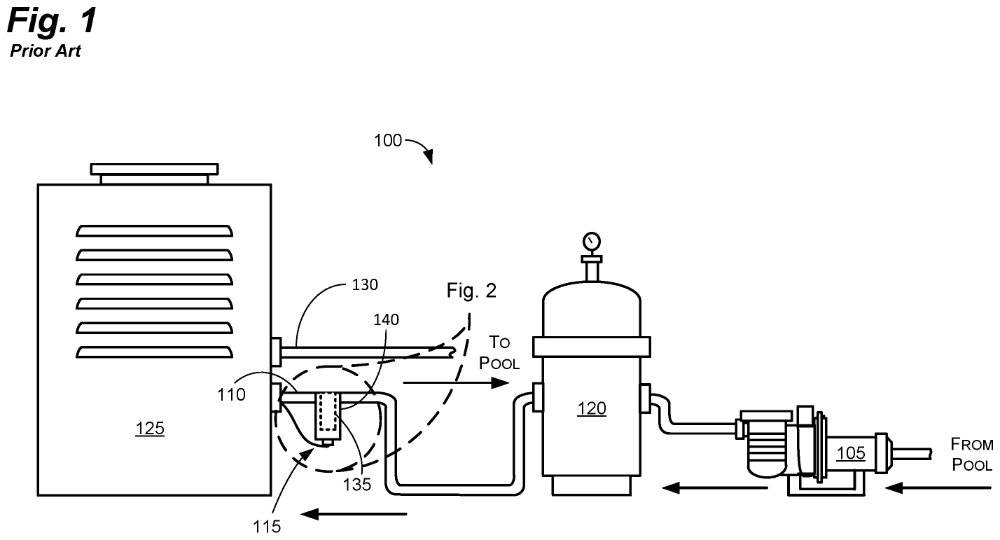

FIG. 2 is a detailed view of the sacrificial anode of FIG. 1.

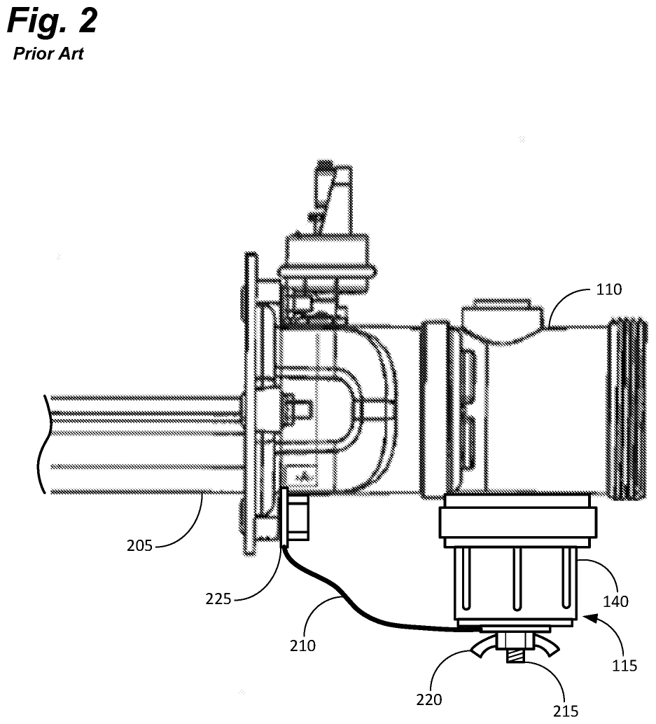

FIG. 3 is a schematic view of an example of a system for monitoring cathodic protection in water heating devices, in accordance with some examples of the present disclosure.

FIG. 4 is a schematic view of an example of a controller for use with the system of FIG. 3, in accordance with some examples of the present disclosure.

FIG. 5 is a flowchart depicting an example of a method for setting up cathodic protection in water heating devices, in accordance with some examples of the present disclosure.

FIG. 6 is a flowchart depicting an example of a method of monitoring cathodic protection in water heating devices, in accordance with some examples of the present disclosure.

FIG. 7 is a detailed view of example components for another example controller for use with the system of FIG. 3, in accordance with some examples of the present disclosure.

FIGS. 8A and 8B are graphs of example voltage degradation rates for the system as the sacrificial anode degrades over time, in accordance with some examples of the present disclosure.

### DETAILED DESCRIPTION

Example of the present disclosure include systems and methods for monitoring cathodic protection on devices subject to corrosion. The system can include a passive sacrificial anode and a reference electrode in physical communication with, and electrically connected to, a component or structure that is subject to corrosion (e.g., galvanic or otherwise). The sacrificial anode is also electrically connected to the component or structure. When a voltage potential exists between the structure and the water, which would normally cause the component or structure to corrode, the sacrificial anode corrodes instead. This prevents the corrosion of the component or structure.

To monitor the condition of the sacrificial anode, and thus the protection level provided thereby, the reference electrode can be electrically connected to an electronic measurement device (e.g., a multimeter) and the structure. The difference in the electrical properties (e.g., voltage, resistance, etc.) between the reference electrode and the structure can be monitored over time and can be used to calculate an anode protection level (APL). When the APL drops below a predetermined level, an alert can be provided to inform a user that the sacrificial anode needs replacement.

For ease of explanation, the system is described herein with reference to a pool heater. One of skill in the art will recognize, however, that the system can be applied to a variety of water heating devices including hot tub heaters, boilers, commercial water heaters, and residential water heaters. Indeed, the system can be used anytime a sacrificial anode is used to protect metal components (e.g., boats, docks, bridges, underwater cables, plumbing, oil derricks, etc.). And, while the system is shown below using simple multimeters to measure potential, other tools could be used including, for example, dedicated circuit boards, inductive amp probes, field programmable gate arrays (FPGAs), etc. Indeed, the electronic measuring device can be integrated into a system controller that monitors the electrical properties and acts when necessary.

The terms electrical potential, voltage, direct current voltage (or, Vic) are used herein interchangeably. These terms are used in the normal way to represent an electrical potential or “voltage drop” in the system. In addition, the term “corrosion” is used throughout and is intended to include all types of corrosion including, but not limited to, galvanic corrosion and the typical corrosion induced on metal parts when in contact with water. In addition, while the term “sacrificial anode” is used throughout, this term is intended to refer to “passive” anodes, as opposed to powered anodes, which have different features and properties and may require different, or additional, components.

Example embodiments of the system will be described more fully below with reference to the accompanying drawings. Water heating devices, the monitoring system, and the specific layout of the system, however, may be embodied in many different forms. As a result, this disclosure should not be construed as limiting; rather, these examples are provided so that this disclosure will be thorough and complete, and will fully convey the scope of the system to those of ordinary skill in the art. Like, but not necessarily the same, elements (also sometimes called components) in the various figures are denoted by like reference numerals for consistency.

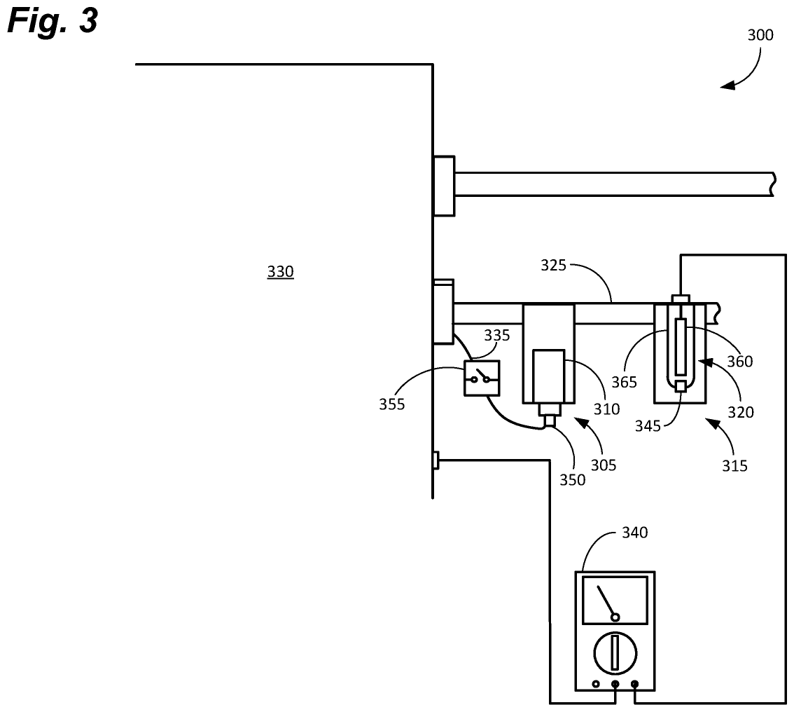

FIG. 3 depicts a monitoring system 300 for passive sacrificial anodes, in accordance with some examples of the present disclosure. As shown, the system 300 can comprise a sacrificial anode assembly 305, with a sacrificial anode 310, and a reference electrode assembly 315, with a reference electrode 320. The assemblies 305, 315 can be installed such that the components 310, 320 are in physical contact with the water flowing through the system 300. In this case, the assemblies 305, 315 can be mounted to an inlet pipe 325 on a water heater 330. Of course, the assemblies 305, 315 could be installed on other components of the system 300 and could be built into the same component assembly. More broadly, the water heater 330 could be any device that has metallic components in contact with water for which corrosion protection is desired.

As shown, the sacrificial anode 310 is also in electrical communication with the water heater 330 via a bonding wire 335 or other suitable conductor. When an electrical potential exists between the water and the components of the water heater 330, the sacrificial anode 310 corrodes, so that the anode material is consumed instead of the metal components in the water heater 330. This can prevent rust and holes in the components, maintain the electrical, material, and structural properties of the components, and prevent the corrosion of components (e.g., water pump impellers), etc. The bonding wire 335 can be connected and disconnected from the structure using a switch or bonding relay 355, the purpose of which is discussed more fully below.

The system 300 can also include one or more electrical measurement devices 340. For simplicity, in this example, the system 300 is shown with a multimeter 340. In some examples, the multimeter 340 can be in the form of, or integrated into, a controller with suitable electronics to measure the desired electrical properties (e.g., direct current voltage or Vic), provide monitoring, and provide alerts when the sacrificial anode 310 is due for replacement.

The system 300 can also include the reference electrode 320. The reference electrode 320 can include an outer tube 365, a porous junction 345, and an electrode 360. The outer tube 365 can comprise, for example, glass or acrylic and can contain a suitable electrolytic solution. The electrode 360 can comprise a suitable material and can be in electrical communication with the positive lead of the multimeter 340. The electrolytic solution, in turn, can be in electrical communication with the water in the system 300 via the porous junction 345. In this manner, the multimeter 340 can measure the electrical potential of the entire circuit—i.e., the sacrificial anode 310, the reference electrode 320, the water heater 330, the water, etc. As mentioned above, as the sacrificial anode 310 is depleted, the reference electrode 320 remains unchanged, and any drop in voltage potential in the system 300 is almost entirely due to the degradation of the sacrificial anode 310. Thus, this change in electrical potential enables the degradation of the sacrificial anode 310 to be monitored. In one example, the electrode 360 can comprise, for example, silver chloride and the electrolyte can comprise a potassium chloride/silver chloride solution. Of course, other electrode 360 and electrolyte combinations are possible and are contemplated herein.

As shown, both components 310, 320 are in electrical communication with the water in the inlet pipe 325. The reference electrode 320 can be connected to the water heater 330 via the multimeter 340, with the positive terminal of the multimeter connected to the reference electrode 320 and the negative terminal of the multimeter connected to the water heater 330. As mentioned above, the sacrificial anode 310 is connected to the structure via the bonding wire 335. Both circuits are completed by the water in the inlet pipe 325 and water heater 330.

The bonding wire 335 can also include a bonding relay 355. The bonding relay 355 can have an open (disconnected) position and a closed (connected) position. In the open position, the sacrificial anode 310 is disconnected from the system 300, which simulates the sacrificial anode 310 being completely depleted (or not installed at all). In other words, if the sacrificial anode 310 were completely depleted, it would have no effect on the electrical properties of the system 300, which is simulated by removing it from the circuit with the bonding relay 355. When the bonding relay 355 is closed, on the other hand, and the sacrificial anode 310 is new, this represents the circuit with 100% APL. Over time, the electrical potential of the system 300 with the bonding wire 335 connected can be measured, with any drop in voltage (i.e., as compared to 100% APL) representing the current condition of the sacrificial anode 310. In some examples, it may be desirable to use a “normally closed” bonding relay 355. In this manner, if the bonding relay 355 fails, the system 300 can perform the “open voltage” test, but cathodic protection is maintained. In the event of failure, the system 400 (described below) can provide a warning message to the user or to a maintenance company.

Take for example a system 300 that when the bonding wire 335 is connected and a new sacrificial anode 310 is installed has a voltage reading of 0.5 volts. The same system 300 with a half depleted sacrificial anode 310 has a voltage 0.25 volts. In this example, using a linear function, a system 300 voltage of 0.25 volts would represent a 50% depletion of the sacrificial anode. The voltage potential when the sacrificial anode is completely depleted may be a low as 0.01 volts. Of course, as discussed below, the degradation of the sacrificial anode 310 may be non-linear in nature, with the sacrificial anode 310 degrading more slowly when new and more quickly when old. The actual function used can vary and can be calculated using empirical measurements, be a simple linear regression, use various mathematical algorithms, or be calculated in any other suitable manner.

To simplify explanation, the sacrificial anode 310 and reference electrode 320 are shown in the figures as separate components. It should be noted, however, that in some configurations one or more of the components of the system 300 could be combined into a single component. So, for example, the sacrificial anode 310 and reference electrode 320 could be combined into a single component (e.g., they could both be housed in the same housing). This may simplify installation, for example, or reduce maintenance times.

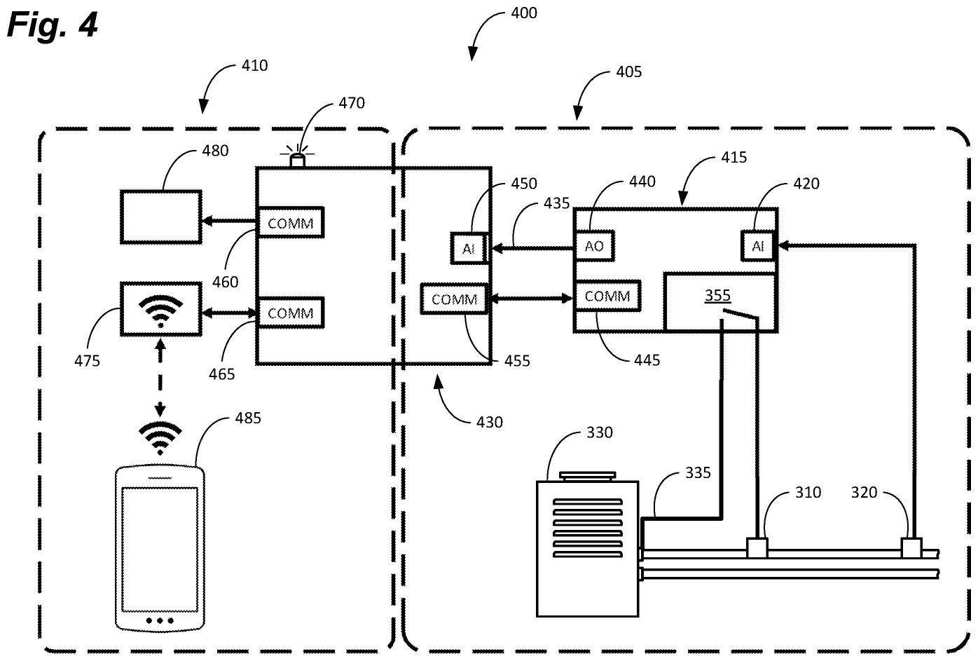

FIG. 4 depicts a monitoring and reporting system 400 for use in conjunction with a system similar to the system 300 of FIG. 3. As shown, the system 400 can comprise a monitoring system 405 and a communications system 410. The monitoring system 405 can comprise an anode controller 415 in communication with the components 310, 320 and the bonding wire 335. The anode controller 415 can also be in communication with a unit controller 430. The anode controller 415 connects and disconnects the sacrificial anode 310 and monitors the voltage of the system 300. In other words, the measurement device (multimeter 340) measures the voltage (electric potential) between the reference electrode 320 (with a known potential) and the water heater 330 with or without the sacrificial anode 310 (with variable potential according to degradation). When the sacrificial anode 310 is electrically connected with the bonding wire 335 (i.e., the bonding relay 355 is closed) to the water heater 330 (or, heat exchanger) the reference electrode 320, sacrificial anode 310, and water heater 330 become one single component (from an electric perspective).

When a difference in voltage in the system 300 reaches various thresholds (e.g., percentages of consumption), the monitoring system 405 can send an analog or digital signal via analog output 450 or digital port 455, to the communications system 410. The communications system 410, in turn, can provide an alert to the user, a monitoring company, or a service company (e.g., a pool company).

In some examples, as discussed above, the anode controller 415 can comprise one or more multimeters or other suitable devices to measure the voltage potential (or resistance, amperage, or other electrical properties) of the system 300. The anode controller 415 can also include the bonding relay 355 to connect and disconnect the bonding wire 335 from the system 300. At installation, when the sacrificial anode 310 is new, the anode controller 415 can measure the voltage of the system 300 with the bonding wire 335 disconnected (APL=0%) and then connected (APL=100%) as part of the initialization routine for the anode monitoring algorithm.

Over time, the anode controller 415 can periodically measure the voltage potential in the system 300 with the bonding wire 335 connected. Any reduction in the voltage of the system 300 represents the degradation of the sacrificial anode 310; and thus, the APL. 100% APL (V_{MAX}) can be used as an upper bound and 0% APL (V_{MIN}) can be used as a lower bound. As the sacrificial anode 310 degrades, the voltage in the system 300 goes down and provides a method for determining the condition of the sacrificial anode 310.

The anode controller 415 can then use the initial voltage, V_{MAX} (the voltage at 100% APL), V_{MIN} (the voltage at 0% APL) and the measured system voltage, V_{N}, to calculate an updated APL, APL_{N}:

$${APL}_{N} = \frac{{V}_{N} - {V}_{MIN}}{{V}_{MAX} - {V}_{MIN}} = \frac{0.35 - 0.25}{0.5 - 0.25} = 0.4 \times 100 = 40 \% APL$$

which correlates to 60% sacrificial anode 310 depletion. In some examples, to improve accuracy and eliminate erroneous measurements, the anode controller 415 can average several measurements (e.g., 5, 20, or 100 measurements) to calculate an average voltage, V_{AVG}, and then an average APL, APL_{AVG}. APL_{AVG} can then be used instead of APL_{N} (i.e., a single measurement), to determine whether the sacrificial anode 310 needs to be replaced.

The APL can also be outputted as a protection measurement signal 435. The protection measurement signal 435 can simply be a number between 0 and 100 indicative of the APL, or can be provided as a voltage, a percentage of new, a status (e.g., new, half, depleted), a “fuel gauge” (e.g., full, ¾, ½, etc.), or simply as a binary output (e.g., (1) good or (2) needs replacement, 1 or 0, etc.). Of course, in other configurations, the anode controller 415 can merely provide raw data to the unit controller 430, and the unit controller 430 can make the necessary calculations and determinations with respect to the condition of the sacrificial anode 310.

The anode controller 415 can also include one or more ports. The anode controller 415 can include, for example, a first port 440 to provide the protection measurement signal 435 to the unit controller 430 and a second port 445 for additional communications with the unit controller 430. The second port 445 can comprise a serial interface, for example, to enable bidirectional communications between the controllers 415, 430. In some examples, the first port 440 can provide raw data, for example, while the second port 445 can provide uni- or bidirectional communications with the unit controller 430 (e.g., via serial, USB, Wi-Fi, Bluetooth®, etc.). In some examples, the second port 445 can receive commands, software and firmware updates, and other data for the anode controller 415 from the unit controller 430. In other examples, the second port 445 can include a direct connection to the Internet, an intranet, or other network to enable the anode controller 415 to receive data directly.

The unit controller 430 can include one or more communications ports, processors, memory, etc. to enable the unit controller 430 to monitor the condition of the sacrificial anode 310 and to periodically provide updates to a user or network. Thus, the unit controller 430 can include a third port 450 in communications with the first port 440 of the anode controller 415 and a fourth port 455 in communication with the second port 445 on the anode controller 415. The ports 450, 455 can each comprise inputs, outputs, or input/outputs. As mentioned above, in some examples, the third port 450 can comprise a dedicated port to receive the protection measurement signal 435 (e.g., a raw data, a percentage of life left, APL, etc.) and the fourth port 455 can comprise a uni- or bidirectional communications port with the anode controller 415. Of course, the configuration shown is non-limiting and other configurations and inputs/outputs could be used.

The unit controller 430 can also include one or more communications ports 460, 465. A first communications port 460 can be in communication with a network adapter 480, for example, to enable the unit controller 430 to communicate, via a wired modem or transceiver, with the Internet, an intranet, or other wired network. This can enable a user to access a website, for example, on which the unit controller 430 provides the current status of the sacrificial anode 310 at any given time. A user could log into a portal, for example, to connect with the unit controller 430 and/or the anode controller 415 and receive the APL, a percentage of the sacrificial anode 310 that remains or has been used, the number of days or weeks the sacrificial anode 310 is estimated to last, the last time the sacrificial anode 310 was changed, etc.

In some examples, the unit controller 430 can also comprise an alert 470 such as a light (shown), siren, speaker, or other alert to inform the user when the sacrificial anode 310 has been sufficiently depleted (e.g., depleted to or beyond a predetermined threshold). In some examples, such as when the alert 470 is a light, the light can be activated (turned on) by the unit controller 430 when the sacrificial anode 310 reaches 60% depletion (40% remaining life), for example, and then start flashing when the sacrificial anode 310 reaches 65% depletion. In some examples, the alert 470 can be located on, or near, the water heater 330, but can be visible to an observer (e.g., located on the outside of a control panel). In other examples, the alert 470 can be remotely mounted to be more accessible. The alert 470 could be placed on the door to a utility room, for example, or anywhere that is convenient to alert the user to needed maintenance.

The alert 470 need only provide enough notice to enable the user to act in a reasonable amount of time. In other words, because the sacrificial anode 310 is generally designed to be depleted relatively slowly, the alert 470 can start out beeping or flashing slowly and then gain in intensity as sacrificial anode 310 life approaches zero. If the alert 470 is a siren, for example, it can start out beeping periodically (like a smoke detector with low batteries) when the sacrificial anode 310 has about 40% life remaining and gradually transition to a fast beep, constant noise, or increase in volume as the sacrificial anode 310 is further depleted.

In some examples, the second communications port 465 can be in communication with a wireless network adapter 475—e.g., a Wi-Fi adapter, Bluetooth® adapter, cellular adapter, etc.—to enable the unit controller 430 to communicate with, for example, a wireless router, cell tower, or microcell to connect to the Internet, an intranet, or other network. In this configuration, a user can log into a portal on their user device 485 (shown), tablet, laptop, desktop, or other device to connect with the unit controller 430 and/or the anode controller 415 and receive the percentage of the sacrificial anode 310 that remains or has been used, the number of days or weeks the sacrificial anode 310 is estimated to last, the last time the sacrificial anode 310 was changed, etc.

In some examples, the unit controller 430 and/or the anode controller 415 can provide an alert to the user when the sacrificial anode 310 reaches a predetermined level. When there is 50% of the sacrificial anode 310 left, for example, the unit controller 430 and/or the anode controller 415 can send an alert to the user device 485, send an email to the user via one of the aforementioned portals, and/or to turn on the alert 470. As mentioned above, the alert 470 can increase in intensity as the sacrificial anode 310 approaches a level at which protection diminishes significantly (typically when the sacrificial anode 310 is somewhere between 60% depleted and 70% depleted). Similarly, e-mail, SMS, or other messages can also be sent to the user device 485 with increasing frequency and/or urgency as the sacrificial anode 310 approaches the APL at which protection is significantly diminished.

And, although shown in close proximity, it is possible that the anode controller 415 and/or unit controller 430 can be located remotely from one another and from the water heater 330. In some examples, the anode controller 415 can be located near the water heater 330, for example, and directly connected to the components 310, 320. Similarly, the unit controller 430 can be located in a control panel or an electrical box near the water heater 330. In other examples, the anode controller 415 can be located near the water heater 330 but connected via a wired or wireless connection to a remote unit controller 430. This can enable the anode controller 415 to be located in a pool house or utility room, for example, and the unit controller 430 to be located in a bedroom or kitchen for easy access. Of course, with modern electronics, the anode controller 415 and the unit controller 430 could be located almost anywhere and connected via a wired or wireless connection to the system 400 (e.g., components 310, 320).

In some examples, because the voltages involved in the system 400 are relatively small (on the order of tenths of volts), it may be desirable to locate the anode controller 415, or at least the voltage measurement portion (e.g., the multimeter 340) of the anode controller 415, as close to the system 300 as possible to avoid voltage loss through the wires. In other words, the longer the wires are that connect the anode controller 415 to the components 310, 320, the greater the voltage loss. This can be compensated for with electronics or can be reduced by placing the system 400, or the multimeter 340, near the sacrificial anode 310 and reference electrode 320. In some examples, the electrical measurement device 340 can be located near the components 310, 320, but can be wirelessly connected to the anode controller 415. In this manner, voltage loss is mitigated, but the convenience of remote mounting is maintained.

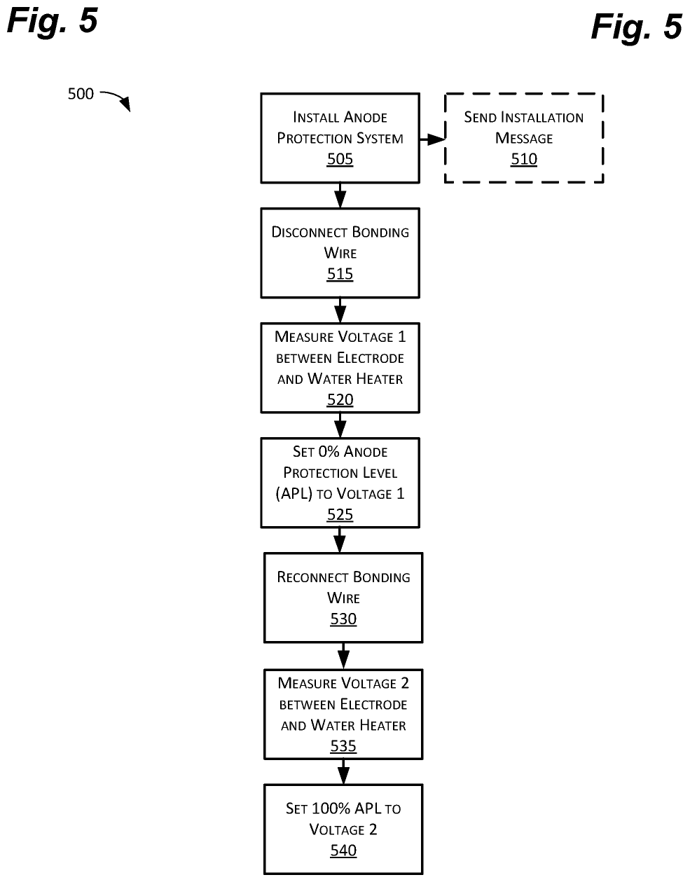

FIG. 5 is a flowchart depicting an example of a method 500 for setting up passive anode protection, in accordance with some examples of the present disclosure. The method 500 install the sacrificial anode 310 and make the initial measurements needed to initialize the system 400. Once initialized, the system 400 can be monitored using a monitoring method 600 (discussed below) and can provide continuous or recurring updates to a user portal, for example, and/or can provide direct alerts (e.g., to the user device 485) when the sacrificial anode 310 reaches a predetermined level or threshold (e.g., 5, 10, 20%).

At 505, the system 300 can be installed on the water heater 330. As discussed above, this can include installing the components 310, 320 on the water heater 330 (or, the inlet pipe 325, in this case) and in contact with the water in the system 300. Installation can also include installing the anode controller 415 and/or the unit controller 430 and making the necessary connections between the components 310, 320, 335, 415, 430 and any network(s). In some examples, at 510, an installation message can be sent to the user, a user portal, a website, or one of the controllers 415, 430, for example, indicating that the system 300 has been installed. This can be an email or an SMS message, for example, sent to the user device 485.

After ensuring that the system is operational (full of water), at 515, the bonding wire 335 can be disconnected from the system 300, electrically disconnecting the sacrificial anode 310 from the circuit. At 520, the voltage of the system 300 can be measured with the sacrificial anode 310 disconnected. Thus, the method 500 includes measuring the voltage potential (e.g., with the multimeter 340), for example, of the circuit that includes the reference electrode 320, the water heater 330, as completed by the water in the system 300. This measurement represents the system 300 with no anode protection, or 0% APL. At 525, therefore, 0% APL can be set to the measured voltage Vo, or some represented number therefor.

At 530, the bonding wire 335 can be reconnected (e.g., the normally-closed bonding relay 355 can be closed) reconnecting the sacrificial anode 310 to the water heater 330 to initiate anode protection. As discussed above, the sacrificial anode 310 can be connected to a metallic portion of the water heater 330—e.g., a metal heat exchanger, pipe, or other metallic component and can also be in communication with the water in the water heater 330.

At 535, the voltage of the system 300 can again be measured, but with the sacrificial anode 310 in the circuit. Thus, the method 500 measures the voltage potential (e.g., with the multimeter 340), for example, of the circuit that includes the sacrificial anode 310, the reference electrode 320, and the water heater 330 as completed by the water in the system 300. This measurement represents the system 300 with 100% anode protection, or 100% APL. At 540, therefore, 100% APL can be set to the second measured voltage V₁₀₀, or some represented number therefor.

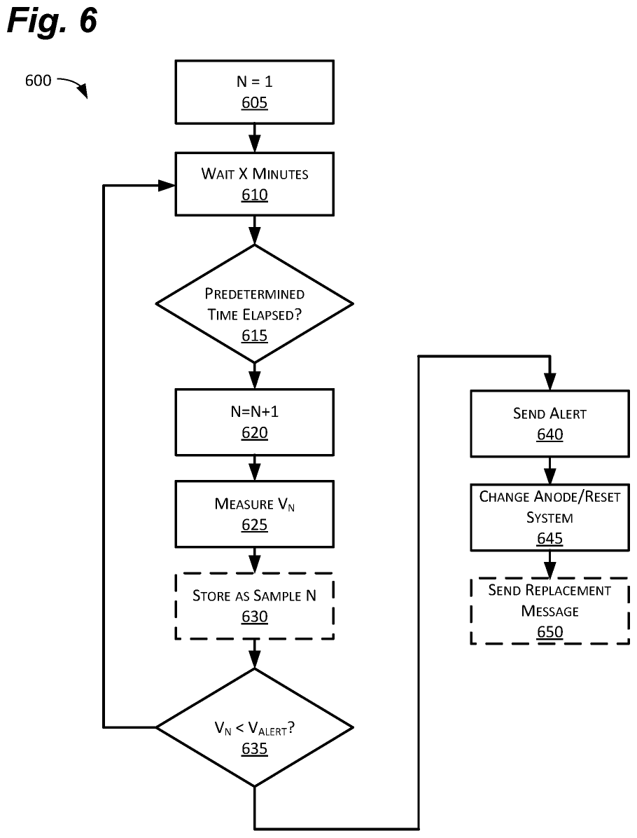

FIG. 6 is a flowchart depicting an example of a method 600 for monitoring the system 300 over time. As mentioned above, as the sacrificial anode 310 is depleted, the system 300 voltage goes down. This can be used to indirectly measure the deletion level of the sacrificial anode 310, or conversely, the APL (i.e., 45% depletion=55% APL).

When the measurement of the system 300 is periodic (as opposed to constant) the controller (e.g., the anode controller 415 or unit controller 430) can be programmed to wait for a predetermined amount of time between measurements. This can be set at the factory or can be set by user preference (e.g., via a user portal), among other things. Since sacrificial anodes 310 are generally designed to last for weeks, months, or even years, practically, the sample rate can be fairly low (e.g., every several hours, daily, weekly, or even monthly). Of course, there is no real cost to monitoring the system 300 using modern electronics, so a higher sample rate does not carry any particularly negative implications and obviously provides higher resolution data.

In a system 400, where the APL is averaged for accuracy, the sample measurements over time can be stored in one of the controllers 415, 430 and a counter, N, can be used to label the samples and to calculate the averages. To this end, at 605, the counter, N, can be initialized (i.e., set to 0) to represent the number of samples taken thus far (none). At 610, the method 600 can wait for a predetermined amount of time (e.g., a certain number of clock cycles for a central processing unit (CPU) in one of the controllers 415, 430).

At 615, the method 600 can determine if the predetermined time has elapsed. If the predetermined time has not elapsed, then at 610, the method 600 can simply wait and check again until the timer expires. Once the predetermined time has elapsed (based on the desired sample rate), then at 620, the counter, N, can be incremented by one to be used for various calculations and to label any stored data. N can represent the number of samples that have been taken since the system 300, 400 was initiated, for example, or since the sacrificial anode 310 was replaced and the system 300, 400 was reset. Thus, if the sample rate is 24 samples per day and the system 300, 400 was reset one year ago, for example, then the last sample of the year in a non-leap year would be N=8,760 (24×365). N can be incremented by one with each new measurement, as discussed below.

At 625, the method 600 can measure the electrical properties of the system 300. As the sacrificial anode 310 depletes, the voltage of the system 300, for example, will tend to go down. Thus, the voltage can drop from 0.2 volts to 0.15 volts, for example. Of course, this is only an example and will change based on water properties and the size, material, and design of the various components (e.g., components 205, 310, 320, 330), among other things. As mentioned above, the voltage can be used to calculate the APL. Thus, the present voltage, V_{N}, can be used.

At 630, if desired, V_{N} can be stored as sample N (in this case Vi) for future use. This can be stored in the memory (e.g., non-volatile memory) of one, or both, of the controllers 415, 430 or can be sent to a remote server, cloud storage, customer portal, or other remote device via a network connection. The samples can be stored and can be used to plot depletion rates, predict 100% depletion, schedule alerts, etc. This step is shown in dotted lines in FIG. 6 because it is optional. In other words, while storing and analyzing the samples over time can be useful in some configurations, it is not necessary to the functioning of the system 300, 400. The system 300, 400 could also simply measure V_{N} and then determine if it is above or below V_{MIN}.

At 635, the method 600 can determine whether V_{N} (or V_{AVG}, discussed below) is above or below a predetermined threshold, V_{ALERT}. The predetermined threshold can be set by the manufacturer of the water heater 330, for example, by a maintenance or utility company, or by the user. The predetermined level can be set at any level that enables the user to replace the sacrificial anode 310 prior to the sacrificial anode 310 being depleted to the point that cathodic protection is significantly affected. Thus, V_{ALERT} can take into account the degradation rate of the sacrificial anode 310, for example, including a reasonable amount of time (e.g., one or two weeks) for the user or service company to replace the sacrificial anode 310. Thus, V_{ALERT} can be sufficiently above V_{MIN} to provide sufficient notice to the user to replace the sacrificial anode before actually reaching V_{MIN}.

Of course, V_{ALERT} can also be set according to user preferences. In other words, more maintenance minded users may wish to replace the sacrificial anode 310 earlier (e.g., at 50% APL). Other users may wish to deplete as much of the sacrificial anode 310 as possible, on the other hand, without sacrificing cathodic protection. A system 300, 400 installed on a vacation house, on the other hand, may be set to start alerts sooner, for example, than a system 300, 400 installed in a primary residence.

The point at which cathodic protection begins to suffer is system dependent, but is normally somewhere between 45% APL and 30% APL. Indeed, experimental testing has shown that in an example system, cathodic protection remained fairly constant until approximately 33% APL, and then dropped off fairly quickly. In this case, the system 300, 400 could be set to begin alerts at 40% APL, for example, and then ramp up the alert urgency at 35%. Of course, these are only examples, and other systems could have different inflection points and need different set points for the alerts.

Advantageously, because the system 400 provides more accurate measurements of the APL, the sacrificial anode 310 can be replaced later in its life cycle. In other words, rather than replacing the sacrificial anode 310 based on time or a general estimate of life, the system 400 provides direct feedback. Currently, after-market anodes are replaced at 50% life because there is no monitoring; but monitoring allows more anode life before replacement. Thus, rather than having to replace the sacrificial anode 310 earlier in its life cycle to provide a sufficient safety margin—e.g., estimating when the sacrificial anode 310 will be around 50% APL and replacing it to avoid issues—the sacrificial anode 310 can be replaced closer to the inflection point at 40%, or even 35%, APL. This reduces maintenance costs and more efficiently utilizes the anode material, among other things.

In some examples, rather than using V_{N}, the method 600 can calculate the average voltage, V_{AVG}, and/or the average value for APL, APL_{AVERAGE}. In this case, because this is the first sample, V_{AVG} is the same as V_{N}. But, as more samples are taken, the number of samples that can be included in V_{AVG} increases. In some cases, if all of the previous samples are to be included, the V_{AVG} is simply the sum of all measured voltages divided by N. Of course, it may be desirable to use only the last 5 or 20 samples, for example, and the calculation can be changed accordingly (e.g., for a five entry average−(V_{N}+V_{N-1}+V_{N-2}+V_{N-3}+V_{N-4})/5).

Regardless, by setting an appropriate protection level for the alerts, the user is provided with ample time to replace the sacrificial anode 310 even if, for example, the user has to order a new one. In this manner, the water heater 330 always has cathodic protection, increasing the life of the water heater 330 and reducing maintenance. If the anode protection level is above the predetermined threshold, then returning to 610, the method 600 can wait the predetermined amount of time and then take a second electrical measurement. This can continue iteratively until the system 300, 400 is reset, for example—e.g., the sacrificial anode 310 was replaced despite not being fully depleted as part of routine maintenance—or until the sacrificial anode 310 is below the predetermined threshold and an alert is needed.

If the anode protection level is below the predetermined threshold (e.g., at 40% APL), on the other hand, then at 640, the system 300, 400 can send an alert to the user, turn on a light or siren, send an email, or take other steps to inform the user to change the sacrificial anode 310. The alert can go to the homeowner, for example, a pool or hot tub maintenance provider, the installer, or other suitable person to ensure the sacrificial anode 310 is replaced in a timely manner. The alert can be sent via a cellular or WiFi connection, for example, to the user or to a service company. In some examples, the controller(s) 415, 430 can send the alert directly to a scheduling system for a service provider, for example, to automatically schedule a maintenance appointment.

At 645, the sacrificial anode can be changed and the system 300, 400 can be reset. This can be achieved by pressing a reset button on one of the controllers 415, 430, for example, logging into a web portal, or by any other suitable means. The method 600 can continue iteratively for the life of the equipment. Maintaining a proper cathodic protection level can reduce costs and maintenance associated with corrosion in the system 300. The sacrificial anode 310 can prevent the corrosion of the metallic parts in the system 300, prevent loss of ground by preventing corrosion of ground connections, and even make disassembly of the system 300 (e.g., the water heater 330) easier by reducing corrosion at the joints.

In some examples, the reset of the system 400 can occur automatically. In other words, the system 400 sends an alert when the electrical properties of the system 300 are sufficiently disparate. By the same token, when the sacrificial anode 310 is replaced, V_{N} returns to V_{MAX} (or nearly so), which also indicates 100% APL. Thus, when V_{N}≈V_{MAX}, the controller(s) 415, 430 can automatically reset the protection level to 100%.

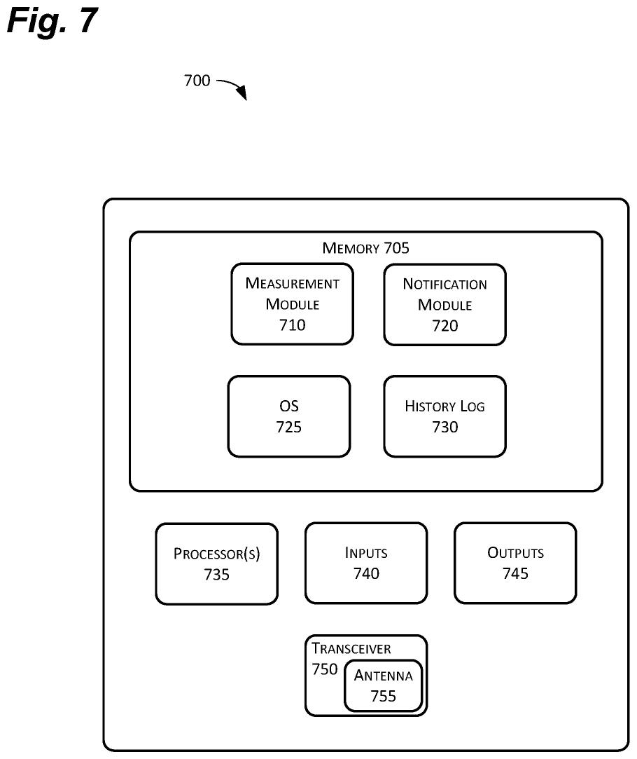

FIG. 7 depicts an example controller 700 for use with the systems 300, 400 and methods 500, 600 discussed herein. The controller 700 can be an example of the anode controller 415, the unit controller 430, a combination of both, or a standalone controller. The controller 700 can be a dedicate microcontroller, for example, or can be a general purpose computer, laptop, tablet, or other device configured to receive the electrical measurements of the system 300 calculate the life of the sacrificial anode 310, send alerts when appropriate, and be reset (or reset automatically) when maintenance is performed. Indeed, the controller could be a desktop computer with a cellular or WiFi connection to enable the computer to monitor the components 310, 320. The controller 700 can include memory 705, one or more processors 735, one or more inputs 740, one or more outputs 745, and a transceiver 750.

In some examples, the memory 705 can include a number of software modules to enable the controller 700 to monitor the system 300, 400 and alert the user. The memory 705 can include, for example, a measurement module 710, a notification module 720, an operating system (OS) 725, and a history log 730. As normal, the OS 725 can control the functions of the controller 700 and can include, for example, Windows, Linux, Apple's OS, Arduino, or other suitable OS.

The measurement module 710 can be in communication with one or both of the controllers 415, 430, for example, or directly in communication with the components 310, 320, and can monitor the change in the electrical properties of the system 300 (e.g., voltage) due to depletion of the sacrificial anode 310. In some examples, the measurement module 710 can be in communication with the multimeter 340, or other suitable sensor, to measure the electrical properties (e.g., the resistance, voltage, etc.) of the system 300. The measurement module 710 can take periodic measurements (e.g., one per minute, per hour, per day, per week, per month, etc.) to monitor the consumption of the sacrificial anode 310. The measurement module 710 can also store these measurements in the non-volatile history log 730 to enable the user to monitor trends or detect anomalies (e.g., the electrical properties of one of the components 310, 320 changing more rapidly than expected), which may indicate a problem. When the difference in electrical properties reaches a predetermined level (e.g., V_{ALERT}), the measurement module 710 can send a signal to the notification module 720. Of course, some or all of the data storage and/or computation could also be performed by a remote server, bank of servers, or “in the cloud.” In some examples, raw data can be sent by the measurement module 710 and can be analyzed to detect trends. The detection of patterns in the data can also be associated with known causes and solutions.

In some examples, the measurement module 710 can also act as a diagnostic module. In other words, if the bonding wire 335 breaks, for example, the measurement module 710 can detect a large/rapid change in the electrical properties of the system 300. Similarly, if the measurement device 340 fails, the measurement module 710 can detect a large/rapid change in the readings for the system 300. In the event of a malfunction (as opposed to the erosion of the sacrificial anode 310), the measurement module 710 can send a diagnostic signal instead of the alert. In some examples, regardless of what the fault is with the system 300, 400, the measurement module 710 can send the same diagnostic signal to the notification module 720 (i.e., regardless of the fault, something needs to be repaired or replaced). In other examples, the diagnostic signal may be different depending on the detected problem and can also include diagnostic codes. So, for example, a rapid change in the electrical properties can be reported as one code, while an open circuit (e.g., one of the leads to the multimeter 340 fails) can be reported as a different code.

The notification module 720 can provide alerts and updates on the system 300, 400 condition, including the status of the sacrificial anode 310. In some examples, the notification module 720 can be in communication with the transceiver 750, for example, to send wired, cellular, or WiFi alerts to the user. In some examples, the notification module 720 can provide different messages depending on what signal is received from the measurement module 710 (i.e., anode replacement or malfunction). In other examples, the notification module 720 can be in communication with the one or more outputs 745 and can activate a light or horn, for example, when certain conditions are met. The notification module 720 can light a yellow light emitting diode (LED) when the sacrificial anode 310 reaches a predetermined level (e.g., 40 or 45% APL), for example, and then light a red LED when the sacrificial anode 310 reaches a second, lower level (e.g., 35% APL).

The history log 730 can store measurement samples from the system 300, 400 (e.g., at step 630 in FIG. 6) over time. Depending on how much data is needed or desired, the history log 730 can store data points every few seconds, minutes, hours, days, weeks, etc. In some examples, the number of samples can be based on the corrosion rate of the sacrificial anode 310. In other examples, since it likely requires very little memory or processing power, the number of samples can be very high to provide more granular data. In some examples, the history log 730 can be used to identify trends for diagnostic and maintenance purposes, provide degradation rates and graphs, and/or other useful data.

The controller 700 can also include one or more processors 735. The processors 735 can comprise commercial processors (e.g., AMD® or Inter), field programmable gate arrays (FPGAs), special purpose chips, etc. and can run the modules 710, 720 and the OS 725 and control the various functions of the controller 700. The processor(s) 735 can receive the inputs 740 and generate the outputs 745 as needed for the controller 700 to monitor the system 300, 400 and alert the user, when needed.

The controller 700 can also include one or more inputs 740. The inputs 740 can include, for example, the multimeters 340 (or other electronic measurement device(s)) to measure the electrical properties of the components 310, 320. The inputs 740 can also include a keyboard, mouse, touchscreen, or other device to enable the user to program, reset, and update the controller 700, among other things. In some examples, the inputs 740 can include a reset button to enable the user to reset the system 300, 400 when the sacrificial anode 310 is replaced or the system 300, 400 is repaired.

The controller 700 can also include one or more outputs 745. As discussed above, the controller can include lights, horns, buzzers, etc. (e.g., the alert 470) to provide system 300, 400 status at a glance. The outputs 745 can include green, yellow, and red lights or LEDs, for example, to indicate high, medium, and low anode protection levels, respectively. In some examples, the outputs 745 can also include a screen or a touchscreen to provide a graphical user interface (GUI) that includes system status, protection level, last anode replacement date, projected anode replacement date, and other relevant information. The one or more outputs 745 can also include a control signal to open and close the bonding relay 355.

The controller 700 can also include a transceiver 750. In some examples, the transceiver can include a wired network adapter, such as a local area network (LAN) or wide area network (WAN) adapter to enable the controller 700 to connect to an ethernet, intranet, the Internet, or other communications network. In some examples, the transceiver 750 can comprise a wireless adapter, such as a cellular, WiFi, or Bluetooth® adapter, to enable the controller 700 to connect wirelessly to an intranet, the Internet, or other communications network. In this configuration, the transceiver 750 can include one or more antennas 755. The transceiver 750 can enable the controller 700 to provide system data to an online user portal, for example, or to send data directly to a user's cell phone or tablet or to a specialized maintenance scanner, among other things. Regardless, the transceiver 750 can enable the controller to send and receive data via a wired and/or wireless connection.

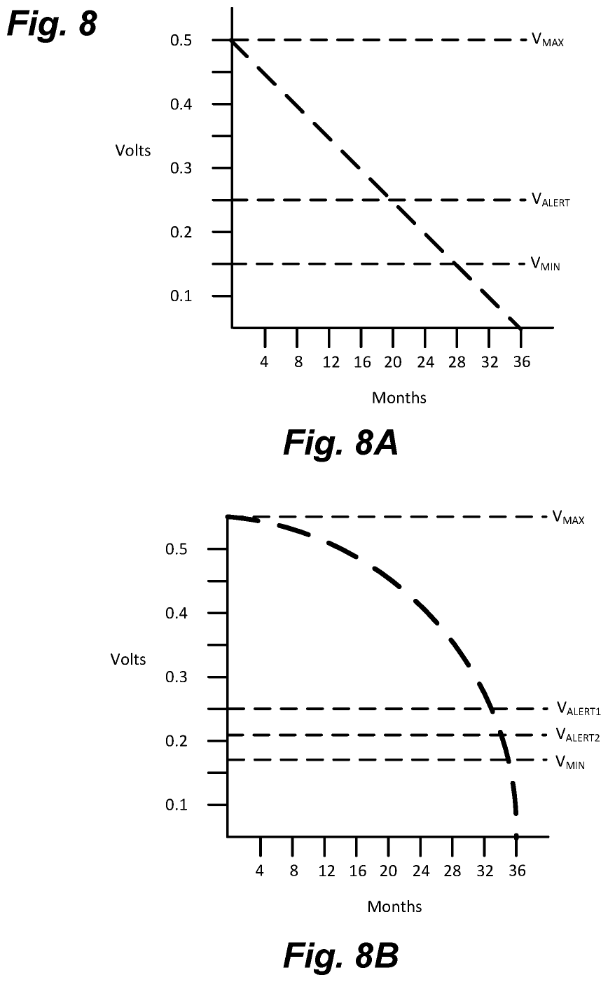

FIGS. 8A and 8B are graphs depicting two possible depletion schedules for the passive sacrificial anode 310. In both cases, V_{MAX} represents the system voltage when the sacrificial anode 310 is new (100% APL) and V_{MIN} represents either the point at which cathodic protection drops off significantly or when the sacrificial anode 310 is fully depleted. As shown in FIG. 8A, the simplest algorithm is simply a linear function over time from V_{MAX} to V_{MIN} based on an expected or measured depletion rate. Thus, when the voltage (and thus, the APL) reaches a predetermined point V_{ALERT}, the system 400 can send an alert to the user.

As shown in FIG. 8B, a more realistic approach may be a substantially exponential algorithm. As mentioned above, experimental evidence shows that cathodic protection is very good until a certain level of depletion (commonly ˜30-35% APL or 65-70% depletion) and then drops off quickly thereafter. As a result, an exponential function is likely more accurate in tracking actual depletion rates of the sacrificial anode 310. As mentioned above, the system 300, 400 may also include a first alert at V_{ALERT1}, when the APL reaches a first level (e.g., 40% APL) and a second, more urgent alert, at V_{ALERT2} (e.g., 35% APL). Thus, the alert may be audible and get louder or visual and increase in brightness or frequency (e.g., for a flashing light).

While several possible examples are disclosed above, examples of the present disclosure are not so limited. For instance, while the system 300, 400 is discussed above with reference to a pool water heater, the system 300, 400 is equally applicable to other types of systems where fluids are in communication with metallic components and create corrosion. Thus, the system 300, 400 could be used on all manner of water heaters, heat exchangers, radiators, marine cooling systems, docks, bridges, etc. In addition, while various features are disclosed, other designs could be used. The system 300, 400 is shown with a sacrificial anode 310, a reference electrode 320, and a multimeter 340, for example, but could use a higher number of anodes or electrodes or different equipment for measuring the electrical properties of the system (e.g., a dedicated FPGA or other chip).

Such changes are intended to be embraced within the scope of this disclosure. The presently disclosed examples, therefore, are considered in all respects to be illustrative and not restrictive. The scope of the disclosure is indicated by any claims filed in a subsequent non-provisional application, rather than the foregoing description, and all changes that come within the meaning and range of equivalents thereof are intended to be embraced therein.

What is claimed is:

1. A system for providing cathodic protection to a device containing water and subject to corrosion, the system comprising:
a sacrificial passive anode detachably coupled to the device and in communication with the water;
a reference electrode detachably coupled to the device and in communication with the water;
a bonding wire electrically coupled to the sacrificial anode and the device via a bonding relay;
an electronic measurement device electrically connected to the reference electrode and the device to measure one or more electrical properties of the system; and
a controller in communication with the electronic measurement device to:
receive one or more signals associated with the measurement of the electrical properties of the system from the electronic measurement device; and
provide a first alert when an electrical property of the system reaches a predetermined level;
wherein the bonding relay comprises an open position and a closed position, and:
in the open position:
the sacrificial anode is electrically disconnected from the device via the bonding wire; and
in the closed position:
the sacrificial anode is electrically connected to the device via the bonding wire.

2. The system of claim 1, wherein the electronic measurement device comprises a multimeter for measuring one or more of voltage, resistance, or amperage.

3. The system of claim 1, wherein the electrical properties comprise a voltage of a circuit comprising the device, the sacrificial anode, the reference electrode, and the water.

4. The system of claim 1, wherein the system further comprises:
a light, a siren, and/or a speaker; and
wherein providing the first alert comprises activating the light, the siren, and/or the speaker.

5. The system of claim 1, wherein providing the first alert comprises:
generating, with the controller, an e-mail and/or a text message; and
sending, with a transceiver of the controller, the e-mail and/or the text message to a user device.

6. The system of claim 1, wherein providing the first alert comprises:
generating, with the controller, a signal to cause the first alert to appear on a web portal associated with a user.

7. A method for providing cathodic protection, the method comprising:
installing a sacrificial anode onto a component exposed to corrosion;
installing a bonding relay in an open position;
creating a first electrical connection between the sacrificial anode and the bonding relay;
creating a second electrical connection between the bonding relay and the component;
installing a reference electrode onto the component;
creating a first electrical connection between the reference electrode and an electronic measurement device;
creating a second electrical connection between the electronic measurement device and the component;
measuring, with the electronic measurement device, a first voltage between the reference electrode and the component;
storing, in a memory of a controller, the first voltage as a zero percent anode protection level (0% APL);
closing the bonding relay to electrically connect the sacrificial anode to the component;
measuring, with the electronic measurement device, a second voltage between the reference electrode and the component including the sacrificial anode; and
storing, in the memory, the second voltage as a 100 percent anode protection level (100% APL).

8. The method of claim 7, further comprising:
measuring, with the electronic measurement device, a third voltage between the reference electrode and the component;
calculating, with the controller, a present APL based on the first voltage, the second voltage and the third voltage; and
determining, with the controller, whether the present APL is above or below a predetermined level.

9. The method of claim 8, wherein the present APL is above the predetermined level, the method further comprising:
setting, with the controller, a timer;
determining, with the controller, that the timer has expired; and
measuring, with the electronic measurement device, a fourth voltage between the reference electrode and the component.

10. The method of claim 8, wherein the APL is below the predetermined level, the method further comprising:
sending, with a transceiver, an alert to a mobile device.

11. The method of claim 8, wherein the APL is below the predetermined level, the method further comprising:
activating, with the controller, an alert located on, or proximate to, the controller.

12. The method of claim 11, further comprising:
receiving, at an input of the controller, a reset signal; and
deactivating, with the controller, the alert.

13. The method of claim 8, wherein the APL is below the predetermined level, the method further comprising:
sending, with a transceiver of the controller, an alert to cause a website to display a message indicating that the sacrificial anode needs to be replaced.

14. The method of claim 7, wherein the controller is a remote server or bank of servers in communication with the electronic measurement device.

15. A system for providing cathodic protection on a device subject to corrosion, the system comprising:
a sacrificial anode detachably coupled to the device, in electrical communication with the device, and in communication with water in the device;
a reference electrode detachably coupled to the device and in communication with the water; and
an electronic measurement device, in electrical communication with the reference electrode and the device, for measuring a voltage of the system;
an alert to provide an audio alert, a visual alert, or both; and
a controller, in communication with the electronic measurement device, and including instructions that, when executed, cause the controller to:
receive, from the electronic measurement device, a first voltage of the system;
determine, with the controller, that the first voltage is below a first alert voltage; and
sending, with a transceiver of the controller, a first signal to cause the alert to provide a first indication.

16. The system of claim 15, wherein the instructions further cause the controller to:
receive, from the electronic measurement device, a second voltage of the system;
determine, with the controller, that the second voltage is below a second alert voltage; and
sending, with the transceiver, a second signal to the alert to provide a second indication;
wherein the second indication is different than the first indication.

17. The system of claim 16, wherein:
the alert is a light,
the first indication comprises blinking the light at a first rate,
the second indication comprises blinking the light at a second rate, and
the second rate is faster than the first rate.

18. The system of claim 16, wherein:
the alert is a speaker,
the first indication comprises beeping at a first rate,
the second indication comprises beeping at a second rate, and
the second rate is faster than the first rate.

19. The system of claim 16, wherein the voltage of the system comprises the voltage of a circuit including the reference electrode, the sacrificial anode, the device, and the water in the device.

20. The system of claim 16, wherein the instructions further cause the controller to:
receive, from a reset button, a reset signal indicating that the sacrificial anode has been replaced; and
sending, with the transceiver, a second signal to the alert to deactivate.
